(19) United States
(12) Patent Application Publication
(10) Pub. No.: US 2020/0129900 A1
(43) Pub. Date: Apr. 30, 2020

(54) HYBRID FILTER FOR HIGH PERFORMANCE PARTICLE, VAPOR AND MOLECULAR COLLECTION

(71) Applicant: BATTELLE MEMORIAL INSTITUTE, Richland, WA (US)

(72) Inventors: Raymond S. Addleman, Benton City, WA (US); Wilaiwan Chouyyok, Richland, WA (US); Xiaohong S. Li, Richland, WA (US); John T. Bays, West Richland, WA (US); Anthony D. Cinson, Walkersville, MD (US)

(73) Assignee: BATTELLE MEMORIAL INSTITUTE, Richland, WA (US)

(21) Appl. No.: 15/897,982

(22) Filed: Feb. 15, 2018

Related U.S. Application Data
(60) Provisional application No. 62/459,451, filed on Feb. 15, 2017.

(51) Int. Cl. B01D 39/10; B01D 46/00; B01D 53/04; C02F 1/00; C02F 1/28

(52) U.S. Cl. CPC B01D 39/10; B01D 46/0036; B01D 53/04; C02F 1/001; C02F 1/288; B01D 2239/0478; C02F 2101/20; B01D 2253/10; B01D 2253/202; B01D 2253/106; B01D 2257/40; C02F 1/281; C02F 1/285; B01D 2253/25

(57) ABSTRACT

A novel integrated filter device for the concurrent capture, filtration or separation of particle, chemicals, vapors and or/gasses from liquid or solid flows. The device has a filtration macrostructure substrate and a thin film coating over the macrostructure substrate which allows for compact and efficient capture, filtration and separations. Device may serve as a platform for chemical reactions. The device minimized problems associated with traditional filters, chemical sorbents or reactors and provided for enhanced collection and analysis of target materials. The methodology for construction also allows for modular assembly in various arrangements including a stacked configuration. The devices may be used collaboratively and cooperatively with other collection and separation technologies.

### PRIORITY

This application claims priority from provisional patent application No. 62/459,451 entitled Hybrid Filter for High Performance Particle, Vapor and Molecular Collection, filed Feb. 15, 2017, the contents of which are incorporated by reference in their entirety.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

The wide range of applications and needs for particle, vapor and chemical collection, separation and filtration are well known. Better filters can address these challenges and provide improved processes with potential applications for enhancing purification of gas and aquatic flows, separation of materials for gas and liquid materials, analytical sample concentration and clean up processes, and enhanced sample analysis. The configurations of filters are specific for a particular application and it's advantageous to have filtration technology assembled for specific application needs. For example, many filters composed of a mesh like structure are effective for filtration of particles from a solution or gas flow down to a certain size range. For many filtration applications it would advantageous to be able to simultaneously do particle filtration (typically done with filter mesh configurations) as well as chemical filtration (typically done with a packed bed of selective sorption material). Hence these types of filtration and or material collection are usually performed with separate devices.

In many instances this is due to the fact that collection and detection are performed by interacting with different properties of a particular substance. For example, trace explosive compounds such as dinitrotoluene (DNT), trinitrotoluene (TNT), research department explosive (cyclotrimethylenetrinitramine) (RDX); triacetone triperoxide (TATP), and Pentaerythritol tetranitrate (PETN), are difficult to collect and detect simultaneously in the same device due to their different vapor pressures and propensity to exist as particles. Some are in vapor, or partial vapor phase, while others are in solid phase at room temperature and consequently present mostly as particles. Similarly, heavy metal contamination in water can be distributed between with the suspended particles and dissolved ions in water. Low levels of lead (Pb) in river water, for example, is an existing relevant health concern and was used evaluated the filter material for aqueous applications. DNT vapor in air was used for evaluation filter material to demonstrate trace organic capture and gas phase applications. DNT is a semi-volatile semi-polar organic, similar to many other many other chemical compounds of interest to health, food safety, transportation environmental and analytical applications. DNT also has specific relevance as a representative signature explosive vapor relevant for the development of trace collection and detection methods for enhanced security technology systems.

What is to address these needs is a single filtration device that can accomplish simultaneous collection of chemicals, vapors and particles without suffering the expected problems with clogging, backpressure, collection efficiency etc. What is also needed is a collection device that provides these features in a smaller space, is simple to use, can be configured for specific applications, requires a short collection time and provides efficient collection of a wide range of materials. The present embodiments describe devices that significant advances capabilities to address and support these needs.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present disclosure provides descriptions and examples of a filter that allows for simultaneous capture of chemical and physical target materials for separation, capture, collection, concentration or filtration from a flow. In its simplest form the device contains a physical filtration macrostructure substrate which could be any of a variety of structures (as described in more detail below) that is coated with a chemical-collecting thin film coating that has been configured to collect the target material. The resulting device provides for targeted concurrent capture, filtration or separation of particles, chemicals, vapors and or/gasses from liquid or slurry flows. The device can be assembled to enable the desired physical (particle) filtration properties as well as the desired chemical capture properties.

In some embodiments the filtration macrostructure substrate could be a material such as a mesh, membrane, porous solid or structure composed of fiber, filament, or wire. The structure is preferably something that is able to retain its stability when exposed to operating conditions which may involve aggressive corrosive chemicals or high temperatures. The chemically collecting thin film coating installed on the filtration macrostructure is typically a material such as a ceramic, metal, polymer, nanomaterial or composites of these materials. The filtration macrostructure coating is preferably porous but need not always be. In some instances the chemical collecting thin film coating can be a nanostructured material with a high surface area such as mesoporous silica or a composite material composed of a polymer and or a polymer sorbent particle composite. Components of this coating may or may not be have specific surface chemistries installed upon them.

In some applications, the filtration macrostructure includes multiple layers of the engineered filter materials intended to sequential capture or modify materials in the flow passing through the integrated system. The thin film coating (and filtration substructure) applied to the filtration microstructure substrate should be thermally stable for the process conditions, both thermally and chemically. In many instances the surface chemistry of the filter is constructed to interact with a target chemical species such as explosives, toxic metals, volatile organic compounds, drugs, radioactive targets, and other chemicals of concern. The chemical collecting thin film coating may be configured so as to collect the target material in such a way so as to enable direct sensing or quantification of the target material from the capture device. Some configuration of the device described may be used in productive conjunction with other filtration modalities such as electrostatic separation, distillation, or chemical precipitation.

In one specific example the device includes a metal mesh filter covered with a composite thin film comprising polyvinylidene fluoride (PVDF) or sulfonated tetrafluoroethylene based fluoropolymer-copolymer such as the one sold by Dupont as NAFION®® together with thiol functionalized mesoporous ceramic particles configured to collect toxic heavy metals (i.e. Pb, Cd, Hg) from water. In another embodiment the device included a metal mesh filter with a porous ceramic polymer composite thin film comprising mesoporous silica particles with a phenyl silane surface chemistry and a PDMS polymer binder configured to collect semi-volative organics, such as DNT and TNT, from an air. The invention is demonstrated to enable better trace collection and direct rapid measurement of the trace compounds, such as DNT, with improved sensitivity.

While a variety of descriptions have been provided, the purpose of the foregoing summary is simply to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. This summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions the document provides examples by way of illustration of various modes contemplated for carrying out the invention. As will be realized, the invention is capable of modification in various respects without departing from the invention. Accordingly, the drawings and description of the preferred embodiment set forth hereafter are to be regarded as illustrative and not as restrictive.

### BRIEF DESCRIPTION OF THE DRAWINGS

FIG. 1 shows an example of a first configuration of the present invention.

FIG. 2 shows a second configuration of the present invention

FIG. 3 shows the results of chemical performance enhancements obtained by coating inorganic thin films on the surface of filter fibers.

FIG. 4 shows the performance of porous ceramic polymer composite thin films compared to pure polymer film and regular metal (stainless steel) mesh.

FIG. 5 shows the performances of porous ceramic polymer composite thin films after they were thermally treated at 120° C. and 375° C.

FIG. 6 shows the performance of inorganic thin film compared to porous ceramic polymer thin films on pretreated metal (stainless steel) mesh filters.

FIG. 7 shows the stability as a function of time for collected DNT on porous ceramic polymer composite thin film coated on metal mesh (stainless steel) compared to regular metal mesh (uncoated).

FIG. 8 shows the effect of functionalized nanostructured material (Phenyl-SiO₂) integrated into PDMS (vinyl terminated) polymer to create sorbent thin films for chemical collection and detection.

### DETAILED DESCRIPTION OF THE INVENTION

The following description includes descriptions of various examples of the present disclosure. It will be clear from this description that the disclosure is not limited to these illustrated embodiments but that a variety of modifications and embodiments thereto are also included. Therefore, the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

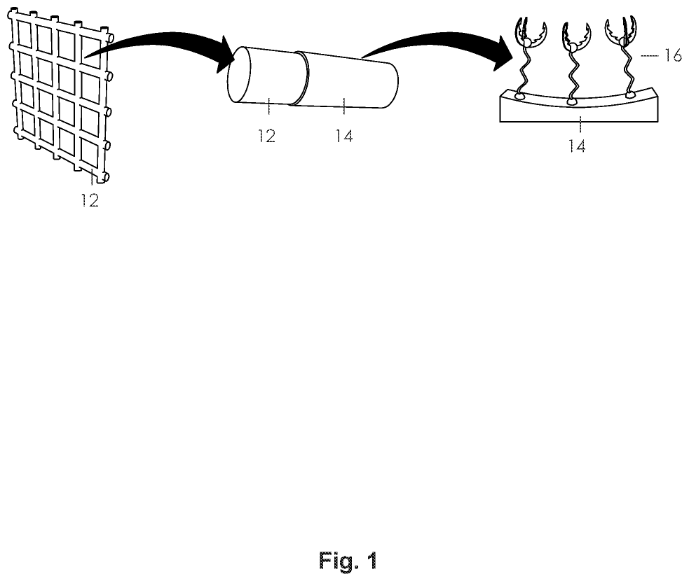

The present embodiments shown in FIGS. 1-8 provide examples of devices which may be used as a dual capture filter and which include a high surface area thin film which has high sorption capacity (chemical, vapor, molecular, nanoparticle) onto a filtration macrostructure (metal, ceramic, polymeric) that provides the physical properties desired (particle filtration, thermal conductivity, thermal stability, electrical conductivity, flow characteristics, size, shape, etc.). The thin films provide high chemical sorption capacity and rapid collection kinetics needed for higher flow rates. The particle filters provide the desired shape, structure, and porosity for the filtration application. This technology provides a synergistic combination of packed bed filtration, chemical and vapor filtration, particle filtration and HEPA filtration.

In an effort to assist the understanding of the overall description as out lined in the drawings the following additional description of those drawings is provided.

FIG. 1 shows an example of one configuration of the present disclosure. The particle capture filter material provides has a mesh size that captures particles above a specific size cut off. The particle filter fibers are coated with the thin-film to provide chemical collection (or reactions) in either the vapor or aqueous phase. This thin-film can have porosity and nanostructure to provide a higher relative surface area and chemical efficacy. The thin-film, internal and external, can have a high affinity surface chemistry to enhance capture/reaction of materials passing through the filter.

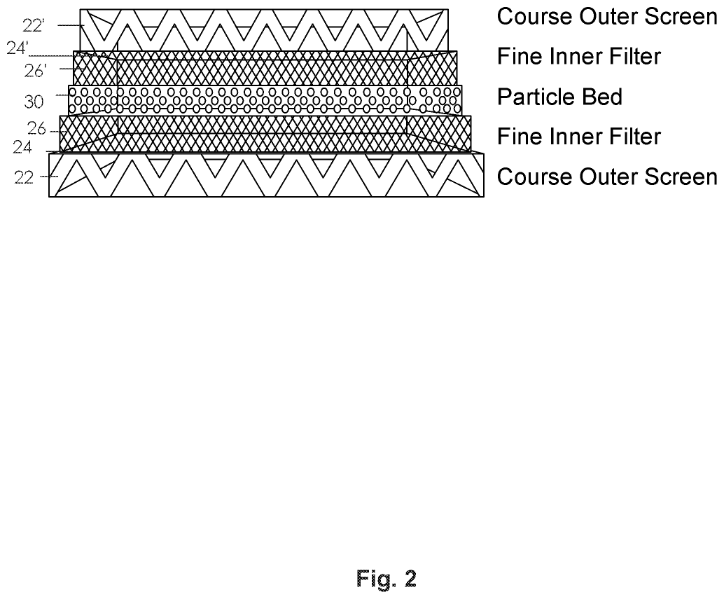

FIG. 2 shows a second configuration of the present invention wherein the hybrid filtration device is composed of multiple layers. The layers provide a serious of functionality. The course of outer screen stops larger objects from impacting and disrupting the inner layers. The finer inner filter can be a particle and chemical collector as illustrated and described in FIG. 1. An optional inner layer of particles can be incorporated to improve the chemical capture process. The structure can be symmetrical to enable material to flow through in both directions as well as enhancing performance.

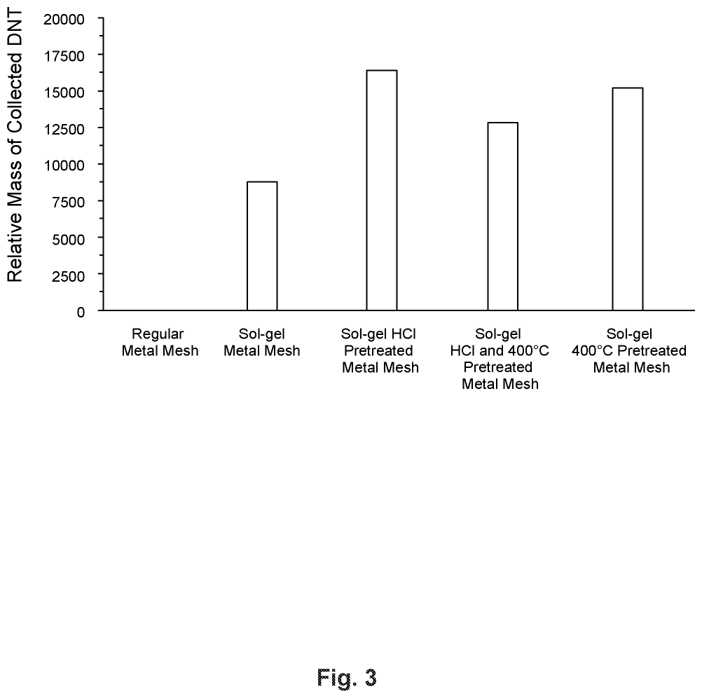

FIG. 3 shows the results of DNT vapor collection from air for sol-gel silica coated on a stainless steel mesh filter substrates in different processing/synthesis conditions. The addition of the porous silica thin-film to the metal particle filter, using sol-gel methods, clearly increases the chemical capture capability of the filter material. Thermal and HCL pretreatment of the stainless steel filter material are also clearly beneficial to performance of the filter. The results shown (y axis values) are normalized to the unmodified/raw stainless steel mesh particle filter (value of 1).

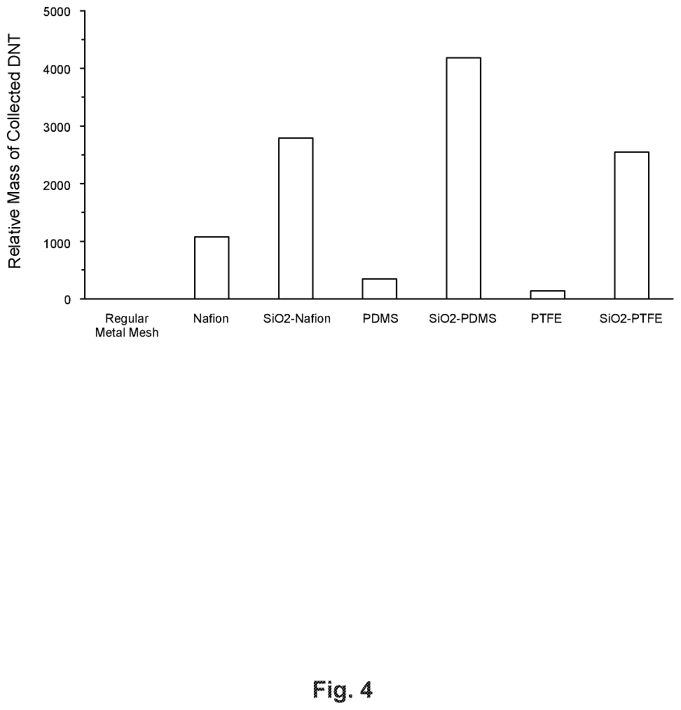

FIG. 4 shows the results of polymer and porous polymer-ceramic composite thin films coated stainless steel mesh filter for DNT vapor collection from air. The addition of the polymer and porous polymer-ceramic composite thin films to the metal particle filter clearly increase the chemical capture capability of the filter material. The addition of porous silica (SiO₂) to the polymers is clearly beneficial. While PDMS (with porous) silica is clearly the best material for this application other polymers may be more appropriate for other applications. The results shown (y axis values) are normalized to the raw stainless steel mesh particle filter (value of 1).

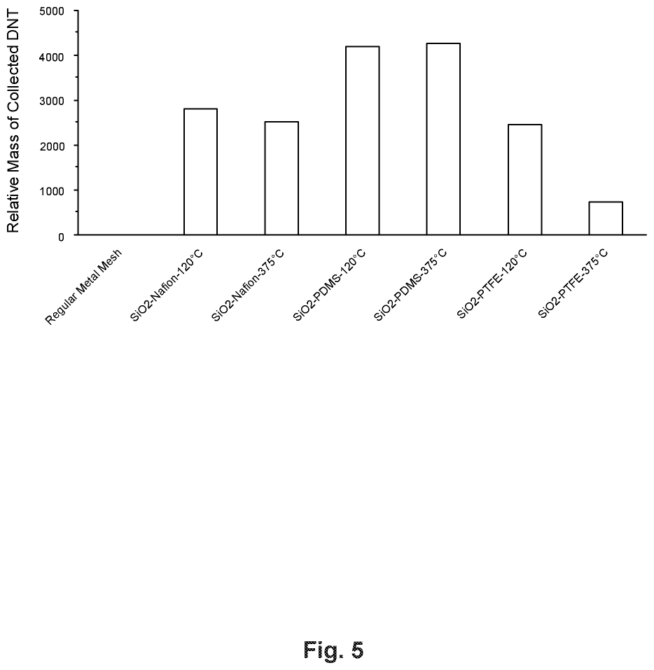

FIG. 5 shows the relative performances of sorbent thin films, installed on metal filter material, for DNT vapor collection from air after the materials were heat treated at 120° C. and 375° C. Thermal treatment is needed to cure the polymer and set the chemically absorbing thin film on the surface or the particle filter. The thermal treatment impacts properties of polymers such as structure, crosslink, and hydrophobic-hydrophilic properties and consequently impacts performance for chemical capture and reactions. PDMS has been shown to provide good thermal stability and performance (for this specific application) The results shown (y axis values) are normalized to the raw stainless steel mesh particle filter (value of 1).

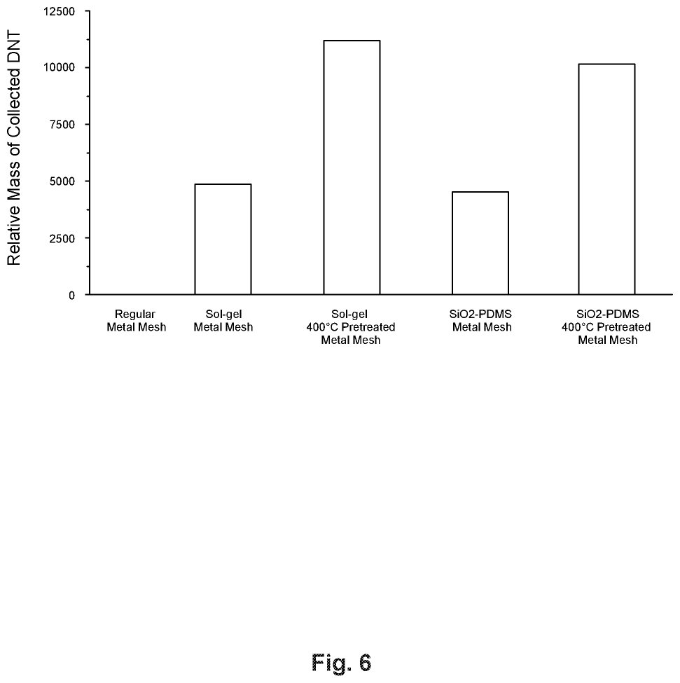

FIG. 6 shows the relative performance, for DNT vapor collection from air, of thin films sorbent coating on stainless steel mesh filters that had been thermally pretreated at 400° C. before application of the sorbent thin film. The thermal pretreatment process is clearly beneficial for the improved collection of trace DNT when compared to untreated/raw metal mesh. What is not shown is that the thermal pretreatment also improves mechanical stability of the device. The results shown (y axis values) are normalized to the raw stainless steel mesh particle filter (value of 1).

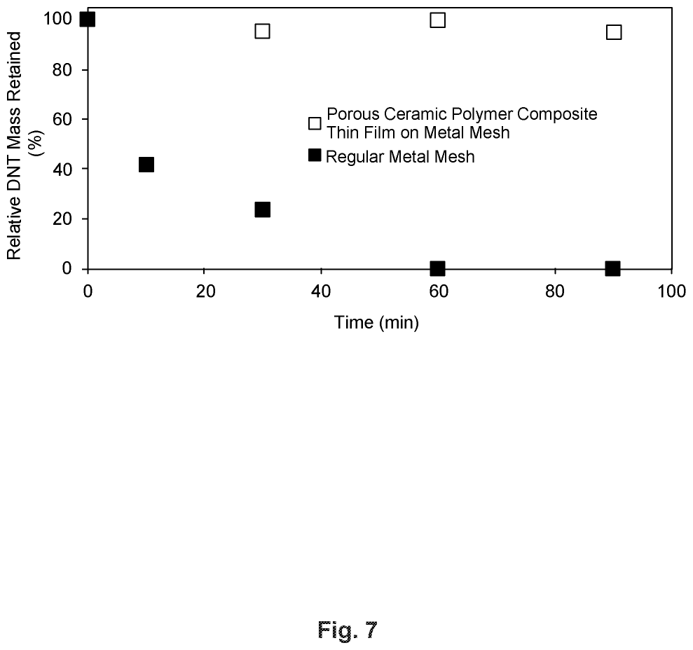

FIG. 7 shows the ability to capture and retain a semivolatile chemical (DNT in this example) using a porous ceramic polymer composite thin film coated on a stainless steel mesh particle filters and is compared to an unmodified metal particle filters. The collected DNT can be observed to be retained by the sorbent modified filter while being quickly lost by the unmodified filter material. Both filter materials were allowed to equilibrate with DNT vapor in a closed chamber. The filters were then removed and exposed to ambient air (no flow, room temperature and pressure). Upon removal the amount of DNT on the filter material was measured as a function of time. This data is for static air, flow conditions would increase the rate of loss of the captured analyte and make the increase the differences in material performance. For this example the sorbent thin film sorbent coating was PDMS with porous silica that had a high density phenyl silane surface chemistry.

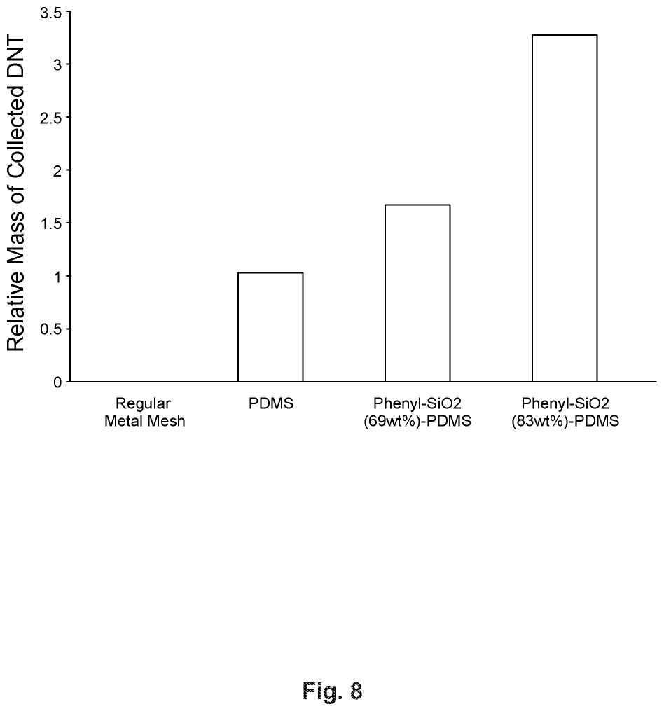

FIG. 8 shows impact of changing the loading of nanostructured ceramic materials in the composite thin film coating (˜1% wt/wt loading). Results show the relative mass of DNT vapor captured from air. The PDMS polymer thin film coating on the metal mesh clearly significantly increases capture/collection. The addition of phenyl functionalized silica to the PDMS clearly improves performance. In this data set the PDMS was modified with porous silica that had high density phenyl silane surface chemistry. FIG. 8 also shows the thin modified materials providing improved capture of trace organics from air and enabling direct assay (with rapid thermal desorption into and ion mobility spectrometer).

Referring now to FIG. 1 in more detail, the example of thin film modified filter structure and a sequential conceptual graphic for assembly of such a filter are shown. In this arrangement a primary grid/filter 12 is selected for desired physical properties such as particle filtration, thermal conductivity, electrical conductivity, flow characteristics and form factor (size, shape, etc.). A thin film 14 applied to the underlying grid/mesh material provides increased chemical capacity, over 10⁴ times the unmodified fiber. These high capacity thin films can be created with range of materials and surface chemistries 16. These surface chemistries 16 installed on a thin film 14 provides desired selectivity, affinity, reversibility for the capture and treatment of any of a variety of target materials.

Similarly, FIG. 2 shows a second configuration of the present invention wherein the dual capture hybrid filtration device is composed of multiple layers. In one configuration coarse outer screens 22, 22′ are used for large particle collection and may or may not be have thin film layer 24 for molecular collection covering them. The inner filters 26, 26′ with a finer structure 28 with thin film layers 24 to provide simultaneous vapor and particle collection. The fine mesh of the inner filter 28 also can act as containment material for the option sorbent particle bed 30, which optionally could provide a final level filtration. This arrangement provides a uniform collection and flow rate through the device and avoids the creation of undesired backpressure which can have negative effects.

These new filters 10, 20 can be applied to liquids or gasses and can be easily engineered chemically and physically for specific applications. The advantage of this technique is that the inorganic and organic compounds that are volatile, semi-volatile and nonvolatile at room temperature can be simultaneously collected on the same device, and then in some instance quantified or analyzed directly from these collection materials. The technology has application to a variety of forms of filtration, collection and chemical processing applications.

The present invention over comes a variety of problems that prior art attempts have suffered from namely back pressure and problems related to flow which had plugged the filter and reduced their operability. The typical thinking was that smaller and smaller devices were required to filter and capture target materials. However, the present description which includes a “macro” type of structure that can support the physical flow stresses and thermal/chemical compatibility. This avoids one of the major problems with prior art membrane separations, plugging by particulates. However, the use of the thin-film coating that has been functionalized for capture of these smaller molecule targets provides for the capture of these smaller target materials. The filter structure described herein can also be configured as a membrane performance. One membrane/device example would be CO separation from CO₂, CO₂ separation from air, or ethanol from water.

The filter structure described here can be applied for purification of large volumes of water. It can simultaneously filter the insoluble and soluble substances without backpressure issues. Insoluble substances such as particles, colloids, humic substances can be captured by the mesh of the filter. The efficiency of the filter for capturing different sizes of insoluble substances in water can be achieved by stacking different layers of various mesh sizes of the filter. Soluble substances such as metals and heavy metals can be captured by the thin film coating on the mesh filter.

The efficiency for capturing of the metals can be achieved by installing high affinity and selectivity surface chemistry on the materials in thin film. When a traditional packed bed column is used for water purification, one of the major problems with packed bed column is plugging by particulate materials. The filter structure described herein will promote better separation, eliminate plugging and backpressure, and add long-life to the filter.

Nanoparticles (NP) and nanofibers can be particularly challenging remove from air and water by filtration because forces and collection mechanisms that work on the molecular and micron scale are not efficient. The filters of this invention can be constructed and operated be modified for improved collection of nanoparticles by electrical charging of the filter for enhanced attraction of the particles, physical templating the thin film coating for particle sizes on interest and installing surface chemistry that is attractive for particles of interest once they hit the surface. Surface modifications discussed below enhance retention of particles that impact surface. Physical templating enables size selective collection of NPs. For inorganic thin films (i.e., silica, alumina, titania) this can be achieved in polymer films by using organic NP sized structures and washing or burning them out leaving nanoscale texture/holes in the films of the desired size. Structures used for imprinting could be nanoscale organic particles (i.e., polymer or cellulose NPs or fibers) or micelles formed from surfactant material. The surface chemistry for NP capture can be a general high-energy attractive surface such as an oxide (i.e., silica or alumina) or modified to be lipophilic—if NPs of specific interest are ligand stabilized.

Combination and modification of a filtration macrostructure (metal, ceramic, polymeric) provides a set of desired physical properties (particle filtration, thermal conductivity, thermal stability, electrical conductivity, flow characteristics, size, shape, etc.) with a thin film (of various formulations such as ceramic, polymeric and composites) that increases chemical and vapor (and potentially nano- and microparticles) collection capacity (up to over 10⁴ times) without significantly altering the physical properties (such as resistance to flow, thermal conductivity, electrical conductivity, etc.). This technology provides a synergistic combination of packed bed filtration, particle filtration, vapor sorption, and HEPA filtration. Individual filters can be created in a modular process with independent selection of support material/particle filters. The coated thin film, from various formulations, is designed to enhance the chemical and vapor sorption capacity. The surface chemistry functionalized onto the thin film is meant to provide the affinity, selectivity, reversibility and others desired properties for specific chemicals and vapors during the filtration process. Some configuration of the device described may be used in productive conjunction with other filtration modalities such as electrostatic separation, distillation, or chemical precipitation

The filter support structure(s) can be made from a range of materials (metal, ceramic, plastic, polymeric, natural fiber, etc.) that provide the physical properties and form factor (i.e., absolute filter rating, bubble point pressure, permeability, porosity, thickness, weight, particle holding capacity, and shape) desired. Properties of particular interest when selecting the filter support materials are particle filtration efficiency, absolute filter rating, thermal conductivity, thermal stability, electrical conductivity and traits that impact flow characteristics such as permeability, porosity and backpressure. Supports made of metal and metal fiber and carbon fiber are generally thermally and electrically conductive, thermal stability, strong, but may be expensive. Ceramic supports provided thermal conduction, are thermally stable, nonconductive and strong but are oftentimes brittle. Supports made of polymers are generally cheap and widely available in many forms however, temperature limitations and poor thermal conductivity can impact their usage.

Sorption into thin films is typically faster than bulkier sorbent configuration (i.e., beads in a packed bed column) promoting the best possible kinetics. This can be further enhanced with the higher fraction of surface area and active sites of the thin film that is exposed for collection (or chemical reaction), and the short diffusion distance within the film. For the solid phase thin films provide a number of advantages, such as high surface area and porosity. The larger the surface area typically offers greater sorption sites, resulting in the higher sorption capacity. Increased porosity of the thin film, further promotes the mass transfer inside the film as well as enabling rapid transport of chemicals or particles into the active sites interior of the film.

Thermal stability, sorption capacity, flexible surface chemistry, and affinity for target analyte are all factors for determining the type of thin film that is to be utilized. Polymer thin films provide certain advantages while inorganic thin films such as silica and silica composite based material provide others. Porous ceramic polymer thin film is an incorporation of nanostructured materials into porous polymers. The combination of these materials have resulted in enhancing of thin film properties, including surface area, affinity, capacity, selectivity, porosity, permeability, hydrophobicity, hydrophilicity, thermal stability, mechanical strength, and anti-biofouling. Moreover, these porous ceramic polymer thin films with sufficient binding site density have showed a fast kinetics for extraction and separation of target analytes.

Nanostructured materials provide many unique properties for chemical processes. High surface area nanostructured materials provide high sorption capacities with adjustable surface chemistries that can provide controlled affinity, selectivity and chemical reactivity. The porous ceramic polymer thin film can overcome the physically fragile, breakdown or flake off of the inorganic thin film, it also overcomes the lack capacity, surface area and selectivity of pure polymer coating.

The surface chemistry of the thin film interacts with the chemicals, vapors, and particles that impact the surface. Material selection (or final modification) of the thin film material(s) determine the surface chemistry. General surface chemistries (i.e., high energy polar surface of many ceramic or lipophilic surfaces of many polymers and organosilanes) can be utilized to enhance general capture and retention. Specific surface chemistries may also be installed to provide more affinity, selectivity, and specific desired interaction for analytes of interests (but also limit general applicability). For examples, in gas phase, a variety of surface chemistries including hydroxyl groups, aromatic phenyl groups, and organometallic groups on thin film have shown to have moderate to high affinity in capturing of explosive compounds. In liquid phase, thiol on a thin film showed high affinity for soft metals (i.e., Ag, Cd, Pb, Hg), while phosphonic groups on a thin film showed excellent sorption for hard metals (i.e., lanthanides and actinides).

Frequently filter media is simply discarded of once saturated or at the end of an operating cycle. However, many configurations of the dual capture hybrid filter media can be regenerated for large numbers of loading cycles. Support structures, thin film composition and surface chemistry can be selected to allow for the operation of thermal and chemical cleaning methods.

For air sampling devices, functionalized nanostructured material thin film coatings on filter supports provide a useful format for the capture and concentration of trace airborne chemicals for a flow of air. Presently metal mesh filters, especially stainless steel mesh, are utilized for particle collection of particles in some filtration and air sampling devices. In this capacity, the filters demonstrate both abilities; the capture of a variety of analytes from solid and vapor phases, and then on command release the captured chemical into an analytical instrument for measurement (or to clean the filter).

The thin film coating used had different physical, chemical, and surface chemistry properties can be coated or modified on metal mesh filters. All thin film coating can be successfully achieved by dip-coating technique although other methods such as spray coating could be used. A variety of slurry solutions and techniques were used for making thin films; including sol-gel ceramics, polymer composites of nanostructured materials (such as SiO₂, Phenyl functionalized SiO₂) and one of these polymers (NAFION®®, PDMS, PDMS-CH₂, PMDS-co-DPS-CH₂, PMDS-co-DPS-OH, PTFE, and PVDF). The composition of solutions and process of making including the calcination or curing temperature for each thin film are different, the details are given as below. In some cases, the filter was pretreated as one of the following method prior the thin film coating: soaking in 2 M HCl solution for 2 hours, calcining at 400° C.-500° C. for 4 hours, soaking in 2 M HCl solution for 2 hours, then calcining at 500° C. for 4 hours.

The preferred non-ionic surfactants used in this study are polyoxyethylene 10 stearyl ether (Brij® 76, C₁₈H₃₇ (C₂H₅O)10OH) from Aldrich or poly (alkylene oxide) block copolymer Pluronic® F-127 (HO(CH₂CH₂O)106(CH₂CH(CH₃)O)70(CH₂CH₂O)106H) from BASF. The templates were first dissolved in deionized water and ethyl alcohol (Aldrich). Concentrated HNO₃ was added to the solution, followed by tetraethyl orthosilicate (TEOS) (Aldrich). The molar ratios of Si:water:ethanol:HNO₃:Surfactant was 1:15-18:30-40:0.06:0.074:-0.004. The solutions were shaken for 20-24 hours at room temperature and then dip-coated on the metal mesh. The excess of solution was absorbed using absorbent cloth. The coated metal mesh were dried at room temperature to 70° C., then calcined at 400° C. in air for 1-4 hours with heating rate of 5° C./min. Table 1 shows molar composition of SiO₂ sol-gel solutions used in forming the thin film coating. The various mixtures provide a final thin film with different pore size, pore morphology, and surface area. The general processes are known by practitioners of the art and examples of specific mixtures explored are showing in Table 1.

TABLE 1
Examples of solution mixtures used to create porous silica thin films.

| Solutions | TEOS | H₂O | ETOH | HNO₃ | C18EO10 | F-127 |
|---|---|---|---|---|---|---|
| 1 | 1 | 15 | 30 | 0.06 | 0.074 | 0.004 |
| 2 | 1 | 18 | 36 | 0.06 | 0.074 | 0.004 |

The porous ceramic polymer thin film is a technique in which nanostructured material is homogenously combined into a polymer. Nanostructured material can be polymeric, metal, ceramic, or carbon based. The surface of some nanostructured materials can be modified with specific functional group in order to increase the affinity and selective for chemical/analytes of interest. Porous and nonporous polymers that can used as a polymer binder include sulfonated tetrafluoroethylene based fluoropolymer-copolymers like NAFION®, various configurations of polydimethylsiloxane (PDMS), such as vinyl terminated PDMS (PDMS-CH₂; a vinyl terminated PDMS variant that is the polymer most commonly used in the examples) as well as others such as PDMS-co-DPS-CH₂, (Poly(dimethylsiloxane-co-diphenylsiloxane) divinyl terminate) PDMS-co-DPS-OH (Poly(dimethylsiloxane-co-diphenylsiloxane) dihydroxyl terminate), polytetraflouroethylene (PTFE) and polyvinylidene difluoride (PVDF) and other similar compounds. DPS is diphenylsiloxane. The coating slurries were prepared from the ball milled sorbent materials (such as MCM-41, Phenyl-MCM-41, Thiol-MCM-41) of ˜0.5 μm particles, then mixed with the polymer desired and a solvent enabling suspension and or dissolution of the mixture materials such as water, alcohol (methanol or isopropanol), toluene, and triethyl phosphate (TEP) by using sonication. The mixture ranges and details of the composition of some thin films are summarized in Table 2. The metal filter was dip-coated with the polymer ceramic particle slurry.

The excess of solution was removed by vacuum filtration or rotation. The coated filters were dried and cured at 120-150° C., then in some cases the coated filter was further calcined at 375° C. in air for 1 hour with heating rate of 5° C./min. The other sorbents materials including fumed silica such as the ones sold as CABOSIL®EH5, and DAVISIL, silica nanoparticles, iron oxide, titanium oxides, activated carbon, grapheme, carbon nanotube can used and replaced the MCM-41 for the same or other purpose and application. The standard vinyl terminated PDMS, PDMS-CH₂, was used.

TABLE 2
Typical Compositions of Porous ceramic
Polymer Composite Thin Films

| | Range Explored for | % Weight for range |
|---|---|---|
| | Thin Film Mass Ratio | of thin film on metal |
| Polymer | Polymer/Sorbent | mesh particle filter |
| Binder Used | (wt/wt) | support |
| NAFION ® | 0.2-0.9 | 0.1-10% |
| PDMS | 0.2-0.4 | 0.5-5% |
| PDMS-CH₂ | 0.2-0.4 | 0.5-5% |
| PDMS-co-DPS-CH₂ | 0.2-0.4 | 0.5-5% |
| PDMS-co-DPS-OH | 0.2-0.4 | 0.5-5% |
| PTFE | 0.11 | 0.5-5% |
| PVDF | 0.4-2.0 | 0.1-10% |

Porous ceramic polymer thin film based NAFION®® polymer is a film with heterogonous surface chemistry where the NAFION®® is used as a binder and MCM-41 was used as a provider of surface area sorbent material that enables high capacity uptake and open porosity provides good chemical capture and kinetics. If a surface chemistry other than silica is desired, the surface silica hydroxyl groups are used for installation of desired surface chemistry. Therefore, in both cases, high surface hydroxyl groups on MCM-41 or other material based silica are desired.

A thin film based upon a composite of PDMS and porous silica ceramic particles (milled MCM-41) polymer is described. PDMS is an elastomeric polymer, a semiporous polymer that is composed of a group of polymeric organosilicon compound It has hydrophobic surface, high thermal stability, high permeability to different gases, biocompatible, antifouling, and excellent release properties and a wide range of chemical stability. Other than native methyl end-group, PDMS is also available in different formulation including end-groups and side structures of vinyl, hydroxyl, hydrogen, and phenyl. The different end-groups and side structures change certain properties of the silicone polymers (i.e. thermal stability and viscosity). PDMS-co-DPS-OH and PDMS-co-DPS-CH₂ are polymer in PDMS family, these polymers have diphenyl rings in the backbone structures. The presence of diphenyl grinds in PDMS change some properties of PDMS such as, hydrophobicity, thermal stability, flexibility, and solubility. Control of these parameters are useful for optimizing the performance of thin films.

Porous ceramic polymer thin film based PTFE, is the same concept as NAFION®-MCM-41. PTFE is known by the DuPont brand name TEFLON® coating various substrates, such as metal substrates, fiberglass. It has high thermal stability which is necessary for thermal desorption of analytes. PTFE is resistant to various chemicals, solvents, mechanical stress, and shredding stresses. However, PTFE has unselective surface chemistry and shown low explosive collection/adsorption. Therefore, MCM-41 is the main material providing binding sites for the capture of explosive vapor, while PTFE provides a stable composite that is stable to temperatures above 350° C.

Porous ceramic polymer thin film base PVDF can also be used in an arrangement similar to the ones described above. PVDF is a fluorocarbon-base polymer, it is a popular polymer for making membranes and thin films for different applications including gas adsorption. Like PTFE, PVDF is inert, chemical resistant and excellent mechanical but much lower curing temperature.

For vapor collection study and application, DNT and TNT were chosen to represent vapor compounds for evaluating the impact of thin films. Regular (uncoated) metal (stainless steel) mesh filter and thin films coating on metal mesh filter, were cut in to a small piece (1 cm×1 cm−3 cm×3 cm). Then, they were exposed to DNT vapors for 2-5 days in a sealed chamber at room temperature. The thin films coated metal mesh filters were exposed to TNT vapor in a separated sealed chamber for 8 weeks. The filter materials were hanged in the chamber so the surface areas of all filters were exposed equally to the vapors.

Two common analysis techniques, solvent extraction and thermal desorption, were used for analyzing the collected DNT on filter. GC-MS (gas chromatography mass spectrometry) was used to analyze collected DNT by solvent extraction. IMS (ion mobility mass spectrometer) was used to analyze collected DNT by thermal desorption. These two methods were used to demonstrate that the coated metal mesh can be analyzed with available instruments and method installed in that work place.

A solvent extraction was used for extracting the captured DNT from the filters (size 1 cm×1 cm, exposed to DNT vapor for 2 days) and subsequently analyzed with a GC-MS. Acetone (0.25 mL) was used for the extraction, the filters and solvent were sonicated for 5-10 minutes in a closed vial. Using a calibration curve, the amount of DNT in nano grams (ng) was determined for each sample. Testing revealed that this straight forward modification of a regular metal mesh filter increased the collection capacity of 7-34 ng of DNT to upwards of 40,000 ng of DNT in the same amount of exposure time and volume of filter materials.

The surface pretreatment for the metal filter, thermal or chemical, helps with adhesion of thin film coating as well chemical performance, as demonstrated with DNT. The clean surface of the metal mesh provides a more uniform and efficient coating by increasing adhesion of thin film on the mesh. This can increase available surface area and binding sites to interact with DNT at the same time-efficient coating can minimize the blocking of mass transfer inside the filter mesh which facilitates the mass transfer of DNT to diffuse into the thin film. This results in large increase of DNT collection compared to materials without surface pretreatment, as can been seen in FIG. 3. The surface pretreatment can be achieved by acid wash and/or calcination at high temperature. The same effect of surface pretreatments can be seen from other thin films based on ceramics or polymer composites. The surface pretreatment prior the thin film coating provides the clean surface that supporting the uniform and efficient coating. This results in better available surface area (and binding sites) for interact with DNT and mass transfer of DNT into the thin film. These examples clearly show that pre-cleaning the support's surface improves coating efficiency.

FIG. 3 demonstrates the chemical performance enhancement of coating inorganic thin films on the surface of filter fibers. The results shown (y axis values) are normalized to the unmodified/raw stainless steel mesh particle filter (value of 1). Table 3 shows this a result of increased surface area. Both FIG. 3 and Table 3 show that chemical (HCl) or thermal pretreatment of the metal filter improved performance. Both pretreatment method remove surface coatings on the filter material and clearly improve device performance. A sol-gel method was used to coat a metal mesh filter for improved chemical collection. The enhancements are demonstrated with enhanced capture of trace DNT vapor from air (in this case a chamber with ˜411 ppb DNT). The sol-gel used was a silica-based material that has hydroxyl groups on its surface that can interact with analytes of interest. The surface hydroxyl groups is a polar surface, this may result in a strong dipole-dipole interaction between the thin film and semipolar molecules such as DNT. Semipolar explosive compounds, such as DNT and other explosives, are known to interact with the hydroxyl groups via their nitro groups. After the coating the particle filter with the silica sol-gel thin films, the filters gained ˜0.5-1.0% (wt/wt) of and had a large increase in surface area to 724 m²/g thin film, or 0.32-0.37 m²/cm²-filter, as shown in Table 3. The installation of the coating increased the surface area ˜1500 times when compared to the regular filter that has surface area only 0.00023 m²/cm²-filter. The result in FIG. 3 shows that the thin film significantly enhances the capacity for trace collection of semivolatile compounds, such as DNT, from air. This is attributed to the high surface of the porous silica installed on the surface and overall high accessible/available sorption sites within the thin film. For increase selectivity and affinity for analyte collection, the surface of the sol-gel thin film can be modified with different surface chemistries, using methods know by those knowledgeable in the art, such as organo-silane grafting.

TABLE 3
Impact of Pretreatment Method on Porous Silica
Coatings on Metal Mesh (stainless steel) Particle Filters.

| | Filter | Surface area |
|---|---|---|
| Filter | Pretreatment | (m²/cm²) |
| Regular metal mesh | None | 0.00023 |
| SiO₂ thin film-metal mesh | None | 0.37 |
| SiO₂ thin film-metal mesh | HCl | 0.46 |
| SiO₂ thin film-metal mesh | 400 C. | 0.41 |
| SiO₂ thin film-metal mesh | HCl and | 0.32 |
| | 400° C. | |

The performance of ceramic sintered thin films is shown in Table 4. Ceramics with different structure were studied. KIT and MCM-41 are mesoporous silica materials and have high surface areas (600-1000 m²/g). KIT has 6-7 nm pores with cubic pore structure, and MCM-41 consists 3.5 nm pores with hexagonal arranged cylindrical structure. CAB-O-SIL® is nonporous silica with lower surface area (˜300 m²/g) and smaller particle size (0.2-0.3 micron). This surface area showed higher performance for collected DNT than KIT and MCM-41. This result indicates that the capacity in collection of DNT are not completely dependent upon surface area or pore structured of the ceramic. It also depends upon the density of hydroxyl groups, which are sorption sites for chemicals such as DNT, on bare silica surface. CAB-O-SIL® has also shown better performance than some other silica materials, such as MCM-41, Davisil, or other systems for capturing uranium from water. The surface hydroxyl density depends upon how the silica was originally processed and its treatment prior to utilization in the thin film.

TABLE 4
Sintered Thin Film Coated Metal Mesh Filter
Semivolatile Organic Vapor collection.

| | Surface Area | Relative Mass |
|---|---|---|
| Sintered Thin Film | of Thin Film | of Collected |
| Coated Filter | (m²/g) | DNT |
| Regular metal mesh | — | 1 |
| KIT-metal mesh | 15.0 | 2700 |
| MCM-41-metal mesh | 15.3 | 2210 |
| Cabosil-metal mesh | 3.6 | 3850 |

All materials were sintered to the filter mesh at 500° C. for 4 hours.

For porous ceramic polymer thin films based polymers, the integration of nanostructured material into polymer thin film can significantly increase surface area of the thin films (see Table 5), which increases available sorption sites for DNT vapor. This results in the enhancement in collection of DNT vapor on porous ceramic polymer thin films compared to pure polymer. Example of the performance of porous ceramic polymer thin films (that were dried/cured at 120° C.) compared to pure polymer thin film are shown in FIG. 4. Note that properties (such as surface area, porosity, thickness, flexibility, and permeability) of porous ceramic polymer thin films coated mesh can be modified by changing composition, mass coating, number or layer of coating and the coating conditions. The key information is the coating and integration of nanostructured material into the coating significantly increases the surface area.

TABLE 5
Surface Area of Porous Ceramic Polymer Composite Thin Films
Coated Metal Mesh (stainless steel) Filter.

| | | | Surface | Surface |
|---|---|---|---|---|
| | | Heat | area | area |
| | Polymer:SiO₂ | treatment | (m²/g-thin | (m²/cm²- |
| Polymer | Ratio | (° C.) | film) | filter) |
| Regular metal mesh | — | — | — | 0.00023 |
| NAFION ®-metal | 100:0 | 120 | 16.1 | 0.005 |
| mesh | | | | |
| NAFION ®-metal | 10:90 | 120 | 778 | 1.88 |
| mesh | | | | |
| NAFION ®-metal | 10:90 | 375 | 840 | 1.76 |
| mesh | | | | |
| PDMS-metal mesh | 100:0 | 120 | 2.5 | 0.002 |
| PDMS-metal mesh | 20:80 | 120 | 755 | 0.63 |
| PDMS-metal mesh | 20-80 | 375 | 840 | 0.65 |
| PTFE-metal mesh | 100:0 | 120 | 0.93 | 0.001 |
| PTFE-metal mesh | 10:90 | 120 | 670 | 0.85 |
| PTFE-metal mesh | 10:90 | 375 | 746 | 0.89 |

PDMS was standard PDMS (vinyl terminated, Sylgard 184 Silicone). The surface area of coated metal (stainless steel) filter mesh was calculated based on the surface area of coating material and the weight percentage of coating.

FIG. 4 shows the performance of porous ceramic polymer composite thin films compared to pure polymer film and regular metal (stainless steel) mesh that were dried/cured at 120° C. (the mesh were not pretreated prior coating). The collected DNT on the mesh were extracted by solvent extraction and analyzed by GC-MS. All thin films of pure polymers and porous ceramic polymers provide the higher collection capacity for DNT vapors than the regular filter. The high capacity results from the huge increase of surface area and porosity of the thin film. The surface area on the coating filters was enhanced average over 4800 times (per cm² of filter). The pure NAFION®® film demonstrates a good performance, it has been reported that explosive vapors have an affinity on porous polymers and plastic materials. The interaction between DNT and the NAFION® film can be physically captured in the pores/voids of NAFION® film, and/or the DNT vapors also can interact with the hydroxyl groups of the sulfonate groups of the NAFION® polymer, also called sulfonic acid, via the dipole-dipole interaction or hydrogen bonding.

The integration of nanoporous MCM-41 into the NAFION® film provides higher surface area and sorption sites of the thin film. The hydroxyl groups on the surface of MCM-41 play the main role for the interaction with nitro group of DNT compound. Moreover, adding porous material/particles also enhances the porosity of the thin film which facilitates the mass transfer of analytes into the thin film. As shown in these results, the greater performance can be seen from the SiO₂-NAFION® thin film coated on stainless steel metal mesh filter.

PDMS polymers have been shown to have affinity for organic compounds. It is a standard widely used polymer in devices for collection and detection of volatile and semi-volatile compounds. The results in this work show PDMS has a lower surface area than the NAFION®—based pure polymer thin film contributing to poorer performance (for the pure polymers). However, the porous ceramic polymer thin film of SiO₂-PDMS had significantly higher performance than porous ceramic polymer thin film of NAFION®. The surface area is increased up to 0.63 m²/cm²-thin film after the integration of nanoporous MCM-41. The surface area of the coating mesh filters was enhanced over 2700 times. The collection capacity is dramatically improved by an increase of surface area and porosity in thin film with integration MCM-41 into the PDMS films.

PTFE is a chemically inert, thermally stable and hydrophobic. Its surface properties and structures change as a function of cure temperature. The porous ceramic polymer thin film of PTFE shows high performance for the collection of DNT, while very poor performance can be seen from the pure PTFE. This result indicates that DNT was mainly adsorbed on the sorption sites of MCM-41.

FIG. 5 shows the performances of porous ceramic polymer composite thin films after they were thermally treated at 120° C. and 375° C. The porous ceramic polymer thin films were coated on un-pretreated metal (stainless steel) mesh filter. The composite thin film of NAFION® only slightly lost its capability for the vapor collection after being treated at 375° C. although typically it is decomposed at temperatures above 280° C. The composite\thin films of PDMS, although its decomposition typically occurs above 355° C., were able to retain their performance after treatment at 375 C. Dramatic reduction in performance can be seen from the composite film using PTFE. This is due to the nature of PTFE polymer, its physical morphology and structure are dependent on the cure temperature. At temperatures of 375° C.; which is above its melting points (327° C.), morphology and structure is converted to extended chain morphology and become a rigid polymer. This leads to the surface, binding sites and pore of MCM-41 being blocked by the rigid form of PTFE, resulting in its poor performance for DNT collection.

The performance of inorganic thin film compared to porous ceramic polymer thin films on pretreated metal (stainless steel) mesh filters are shown in FIG. 6. The coated materials (1 cm×1 cm) were exposed to DNT vapor for 2 days, solvent extraction and analyzed with GC-MS. The metal mesh filter was thermally pretreated at 400° C. prior coating. As shown in FIG. 3, thermal surface pretreatment is effective and has advantages over chemical pretreatment (with something like HCL) because it is green method and does not produce chemical waste. The silica sol-gel was treated at 400° C. for 1 hour. The SiO₂-PDMS (vinyl terminated) was treated at 120° C. overnight. The collection capacity was increased more than 10⁴ times when the thin films were coated on the surface pretreated mesh filter. This result demonstrates that the surface pretreatment of the filter, composition of thin film, and cure temperature can contribute and increase the chemical capture efficiency and increase the performance of the thin film coated filter structure. Note that, these results can be different if there are changes in the composition and mass load of thin film, the coating process conditions, the chemical being collected, and the environment being utilized.

FIG. 7 shows the stability as a function of time for collected DNT on porous ceramic polymer composite thin film coated on metal mesh (stainless steel) compared to regular metal mesh (uncoated). Retention of the captured chemical is key for effective chemical filtration. If materials captured are released under ambient conditions after sticking to the surface the filter material is ineffective. Many porous fiber materials are very effective particle filters but make poor chemical collectors as demonstrated by the metal mesh in FIG. 7. The particle filters have little binding affinity for the chemical vapors and low surface area (relative to nanostructured sorbent particles), resulting in poor capabilities to collection/capture chemicals from the flow. The metal mesh coated with the porous ceramic polymer composite thin film was able to retain collected DNT much better and longer than the regular metal mesh. Collected DNT on coating metal mesh was retained much longer after being exposed to ambient air. The collected material (DNT) was lost rapidly on the unmodified metal mesh, with more than 50% of the collected DNT lost within 10 minutes and all collected material gone in 1 hour. In contrast, the thin film modified metal mesh can retain DNT for many days. The simple results shown in FIG. 7 clearly shown the advantages of modifying particles filter with thin film sorbents to capture and retain trace chemicals. The porous ceramic polymer composite thin film in FIG. 7 was composed of PDMS (vinyl terminated) and phenyl-MCM41 at ratio weight of 0.2 with 1% (wt) coating, and thermally treated at 150° C. for overnight. The metal mesh (size of 3 cm×3 cm) was thermally pretreated at 400° C. for 4 hours prior coating. The coated metal mesh was exposed to low levels (˜411 ppb) of DNT vapors for 5 days in a sealed chamber at room temperature. Then collected DNT on coated filter materials were exposed to air at room temperature and analyzed with a Smiths 400B IMS using a desorption temperature of 120° C.

FIG. 8 shows the effect of functionalized nanostructured material (Phenyl-SiO₂) integrated into PDMS (vinyl terminated) polymer to create sorbent thin films for chemical collection and detection. DNT vapor in a sealed chamber was used to measure the material collection efficacy and detection was done by IMS thermal desorption technique previously described. It can be clearly observed in FIG. 8 that the addition of the phenyl functionalized porous silica ceramic to the polymer significantly improves the collection (and subsequent detection of DNT) when compared to a thin film of pure PDMS (the same result with solvent extraction and GC-MS technique). The efficacy of the functionalized porous ceramic polymer composite thin film is especially pronounced when compared to the regular metal mesh filter where no measureable DNT was collected or detected. The enhancement of DNT collection is due to the nanostructured silica material providing as higher surface area, open porosity and phenyl surface chemistry providing good sorption sites for the trace DNT vapor in the air. The phenyl surface chemistry clearly has functional groups have been reported to have high affinity for explosives. At the same time, due to π-π interaction between phenyl groups and explosives, phenyl functionalized material based silica also provided quicker release of explosives with thermal desorption than a material with raw silica. An increase of DNT collection can be seen when increasing the loading of nanostructure sorbent materials from 69 wt % (ratio weight of polymer to sorbent was 0.4) to 83 wt % (ratio weight of polymer to sorbent was 0.2). The improvement is simply due to the thin film have more sorbent material, results in higher surface area for chemical collection. It should be noted that some polymer binder is needed to provide film stability and the optimal ratio is dependent upon the material and application. The different compositions of porous ceramic polymer affect the thin film properties (such as surface area, porosity, thickness, flexibility, permeability, and carry over of the chemical/analyte). The porous ceramic polymers were prepared and exposed to DNT vapors the same method as result of FIG. 7. The collected DNT on coated and uncoated metal mesh were bench exposed to air at room temperature for 1 hour prior analysis with a Smiths IMS 400B at desorption temperature of 230° C.

As shown in FIGS. 5-8 and Table 6 the porous ceramic polymers composite thin films provided significant improvement for chemical capture by the filter material. Many volatile and semi volatile chemicals can be released from these screens by heating. Table 6 (and Table 7) shows the thermal release of semi-volatile organic compounds. The hot the thermal cycle the faster the release. Some lower volatility, or tightly bound materials also require higher temperatures for release. Thermal cycles can be used for cleaning of the filters or as part of a process such as trace analytical work. FIGS. 6 and 7 shows thermal release and direct subsequent trace analysis with an IMS. Table 3 shows thermal cycling to 300 C and the materials demonstrated stable performance after numerous thermal cycles.

TABLE 6
Performance of Selected Porous Ceramic Polymer Composite Thin
Films on Metal Mesh for Capture of Semivolatile Organics from Air

| | Relative DNT |
|---|---|
| Thin Films Coated Metal Mesh Filter | Mass Collected |
| Regular metal mesh | 0 |
| PDMS-metal mesh | 1 |
| Phenyl-SiO₂-PVDF-metal mesh | 1.8 |
| Phenyl- SiO₂-PDMS-metal mesh | 2.6 |
| Phenyl- SiO₂-PDMS-co-DPS-OH-metal mesh | 1.5 |
| Phenyl-SiO₂-PDMS-co-DPS-CH₂-metal mesh | 2.5 |

DNT vapor collected from air by porous ceramic polymers films coated metal mesh were analyzed by IMS 400B at desorption temperature of 300° C. after 1 h bench exposed. The signal of thin film materials was compared to the signal of standard PDMS (vinyl terminated, Sylgard 184 Silicone).

These porous ceramic polymers composites enable in the detection of DNT at the desorption temperature of 300° C. as data shown in Table 6. Typically, DNT is decomposed at temperatures above 250° C., however, from these data, due to the high collection capacity of porous ceramic polymers, results in collected DNT were not completely decomposed and a portion of them were introduced into the IMS instrument. The Phenyl-SiO₂-PDMS and Phenyl-SiO₂-PDMS-co-DPS-CH₂ showed higher performance than other thin films at desorption temperature at 300° C. These results also indicate that these porous ceramic polymers were stable at high temperature and can be employed at high temperature up to 300° C. All porous ceramic polymers were prepared with the same method at 29 wt % of polymer (weight ratio of polymer to sorbent was 0.4), ˜1% weight coating, and thermally treated at 150° C. overnight. The collected DNT on coated metal mesh were bench exposed to air at room temperature, then analyzed with a Smiths IMS 400B at desorption temperature of 230° C.

For collection of TNT vapor, the performance of thin films coated metal mesh (stainless steel) filter is shown in Table 7. All sample filter materials were exposed to TNT vapor in a separate sealed chamber for 8 weeks. TNT has vapor pressure˜9.15×10⁻⁹ atm at room temperature, which is much lower than DNT (˜4.11×10⁻⁷), ˜450 times lower. Therefore, much longer exposure time was needed to ensure the phase equilibrium between vapor and solid phases were reached. The TNT collected on metal mesh filter coating thin films were analyzed with thermal desorption on Smiths IMS 400 B at a desorption temperature of 230° C. The Sol-gel coated metal mesh filter provided significantly higher collection of TNT when compared to the signal for TNT detected from standard pure polymer PDMS, more than 5 times higher. SiO₂-PDMS and Phenyl-SiO₂-PDMS, better performance than sol-gel thin film and more than 8.5 times higher than the pure polymer thin film.

The large increase in performance of sol-gel and porous ceramic polymers are a result of the increase of available sorption sites to the thin films. The impact of porous ceramic polymers for vapor collection can be seen much better with the TNT study in (Table 7) than the DNT (Table 6). The data for Table 6 and Table 7 and FIG. 8 show enhanced collection of DNT and TNT. The measurements of the DNT and TNT on the filter materials was done by rapid thermal desorption (from filter material) directly into an IMS (ion mobility mass spectrometer). These results clearly demonstrated to enable better trace collection and subsequent direct rapid measurement of the trace compounds with improved sensitivity.

TABLE 7
Performance of Selected Sorbent Thin Films on Metal
Mesh for Capture of Semivolatile Organics from Air

| Thin Films on Metal Mesh Filter | Relative TNT Mass Collected |
|---|---|
| PDMS-metal mesh | 1 |
| Sol-gel-metal mesh | 5.2 |
| SiO₂-PDMS-metal mesh | 8.5 |
| Phenyl-SiO₂-PDMS-metal mesh | 8.7 |

TNT vapor collected by porous ceramic polymers and sol-gel coated metal mesh were instantly analyzed at 230° C. after exposed to TNT powder in a sealed chamber for 8 weeks. The signal of thin film materials was compared to the signal of standard PDMS (vinyl terminated, Sylgard 184 Silicone). Raw metal mesh provided no measurable signal.

The sorbent thin film modified filters were also explored for removal of toxic chemicals from water. Mesh filters are known and widely used for removal of particulate material, fine and course, from water. How the filter have poor to nonexistent effectiveness for removal of dissolved chemicals. Sorbent systems that removal chemical from water such as packed columns of particles plug and fail quickly when exposed to water with suspended particles. As previous mentioned the coated particle filter format (metal or other material) is a useful format that can provide dynamic application relevant format that is a strong support with low pressure drop and good contact efficiency. Consequently we explored coated metal mesh particle filters for water clean-up applications. An example of cleaning low levels of Pb from river water shown in Table 8, with selected filter media.

In this set of experiments metal mesh filter coated porous ceramic polymer thin films based NAFIO® and PVDF. SH-Silica (thiol functionalized mesoporous particles milled to less than 0.5 microns) incorporated into polymers provided outstanding performance for capturing Pb from river water.

The mesh of the filter can removed unwanted particles from the water while it simultaneously captures the toxic metals (ions). The performance and capability in filtration of the particles depend upon the sieve size chosen for the support/filter used (>60 μm in this case). The performance in capturing toxic metals depends upon the properties of the thickness (capacity increases with thickness and kinetics decrease) of the porous ceramic polymer thin film as well as the materials used in the thin film (which will impact chemical selective, affinity, and mass loading). The stability of the porous ceramic polymer thin film coating on metal mesh depends upon the composition of the thin film such as type of polymers, type of nanostructured materials, the ratio of polymer to nanostructured material, and mass of porous ceramic polymer thin film coated on the mesh. The filter media can be reused with standard methods; backflushing to clean particulates out and chemical stripping to removed capture compound.

TABLE 8
Examples of Porous Ceramic Polymer Thin Film Coated Metal Mesh
Filter for Removal of Heavy Metal from Natural Water

| Thin Film coated | Pb Collection Efficiency (%) |
|---|---|
| Metal Mesh Filter | from river water |
| Regular metal mesh | 0 |
| NAFION ®-metal mesh | 5 |
| SH-SiO₂-NAFION ®-metal | 65 |
| mesh | |
| SH-SiO₂-PVDF-metal mesh | 97 |

Porous ceramic polymer thin films contained of 54% (wt/wt) and 44% (wt/wt) sorbent loaded into NAFION ® binder, and in PDVF binder, respectively. Filter media was placed in a 50 mL falcon tube and 10 mL (LIS ratio ~8000 mL/g-sorbent) of the Columbia river water (pH-8) containing ~26 ppb Pb metal ions and gentle agitation for 24 hours prior ICP-MS analysis.

The descriptions herein have been focused specifically upon better particle and vapor collector for explosive detection as well as cleaning toxic heavy metals from water. Most work reported was done on metal filters since they provided desired particle filtration, physical strength and thermal conductivity but other filter material could be used. The descriptions herein have been focused specifically upon better particle and vapor collector for explosive detection as well as cleaning toxic heavy metals from water. Most work reported was done on metal filters since they provided desired particle filtration, physical strength and thermal conductivity but other filter material could be used.

In addition to the examples provided, the ability to sequentially install the chemical capture or reaction capability provided through the thin film coverings upon particle filtration media enables construction of a wide variety of application specific-devices possible. Changing the filter media allows adjustment of particle filtration, thermal and electrical and other macro properties. Changing the surface chemistries of thin film allows for changes in the chemical selectivity and provides other preselected characteristics. A series of these structures could be assembled for controlled, sequential, modular filtration/and or processing of flows in gas or liquids or slurries)

The filtration macrostructure (metal, ceramic, polymeric, fiber) provides the physical properties desired (particle filtration, thermal conductivity, electrical conductivity, flow characteristics, size, shape, strength etc.). The thin film coating (of various formulations) that increases chemical, vapor, and nanoparticle collection capacity (up to 10⁴ times—and maybe more depending upon morphology) without significantly altering the (macro) physical properties. This single rugged filter media is a synergistic combination of physical particle filtration, HEPA filtration, chemical and vapor filtration, and potentially nanoparticle filtration. It can facilitate the simultaneous collection of compounds in solid, gas, aerosol and vapor phases (also liquid phase). The ability to sequentially install the chemical collection capability (as a sorbing thin film) upon the particle filtration media/support of interest makes modular construction of application specific devices simple. Such a device can also provide unique capabilities for nanoparticle filtration enabled by tailoring the thin film coating. A number of additional applications for the unique structures assembled are envisioned.

The invention described provides a flexible platform for improved filtration, sorption, collection, preconcentration, chemical processing, and is potential useful for a large number of market sectors including; large volume trace analytical sampling, security monitoring and detection, drug and explosives detection, air sampling, chemical processing and pre-processing, chemical clean-up, catalyst support, controlled flow-bed catalysis, staged catalysis, chemical warfare agents detection, radionuclide detection (air and water), environmental monitoring and detection/assay, heavy metal removal, preconcentration, detection in air and water, organics in air and water, waste stream processes and conversions, environmental remediation, clean up for chemical releases, air filtration devices (for protective applications), improved HEPA filtration, military applications, ventilation systems, personal air filters (gas masks), regeneration, industrial cleanup processing, particle and molecular filtration, chemical and precious metal separations/recovery, membrane separations, biomedical uses such as hemodialysis, blood transfusions, respiratory filtration/collection, synthetic reactions in the pharmaceutical industry, battery and power systems such as battery advancement, fuel cells, separations, purifications. Some configuration of the device described may be used in productive conjunction with other filtration modalities such as electrostatic separation, distillation, or chemical precipitation

Some embodiments of the present invention find applicability wherever filtration capabilities such as higher capacity/separation factor, high affinity, selective, and activity, and/or more robust/rigid structure. In addition to these filtering applications these embodiments can also be used in reactive chemical applications. With appropriately reactive surface chemistries, these structures may have application to chemical processing applications, with sequential catalytic processes an excellent target. A series of these devices can be assembled for controlled, sequential modular solid phase promoted reactions (in gas or liquid phase).

Chemical process with heavy particulate loads (i.e., many bioprocesses) or low tolerance for chemical contaminates (i.e., fuel cells) are particularly promising areas for applications of this technology. Some specific examples for such involvement would include: sorption of sulfur compounds followed by catalysis or fuel cell process, particulate material and sulfur containing chemicals can foul a range of processing chemistries including many catalytic processes and hydrocarbon feeds to fuels cells. The filter structure described could be assembled to filter out particles and scrub sulfur containing compounds with thin film composed of a high surface area sorbent with active soft metal (i.e. Cu, Ag, Cd). Filter regeneration could be thermal or chemical as appropriate. Filters could be constructed at large scale or microscale using a support structure compatible and scalable for the process or interest.

This technology could also be used for syngas clean up. Raw syngas from coal gasifiers contains fine particulates, sulfur, ammonia, chlorides, mercury, and other trace heavy metals. These contaminants have to be removed to meet environmental emission regulations, as well as to protect downstream processes. Hot gas cleaning technologies are attractive because they avoid cooling and reheating the gas stream, therefore the efficiency can be improved. The filter structure could be assembled to filter out particles and adsorb ammonia, chlorides, mercury, sulfur, etc. with thin film composed of a high surface area sorbent. For example, ZnO coating can be used for sulfur removing. In addition the higher the surface area provides for more chemical reactions and better enabled separations (packed bed column chromatography, HPLC, and distillation separations).

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A dual capture filter for simultaneous chemical and physical target material separation, capture, collection, concentration or filtration from a flow said device comprising:
a physical filtration macrostructure substrate coated with a chemical-collecting thin film coating configured to collect the target material.

2. The device of claim 1, wherein the filtration macrostructure substrate comprises a material selected from the group consisting of meshes, fibers, filaments, wires or a porous solid.

3. The device of claim 2, wherein the filtration macrostructure is stable when subjected to aggressive chemicals, acid, temperatures greater than 400° C.

4. The device of claim 2, wherein the filtration macrostructure has a coating made from a material selected from the group consisting of ceramics, polymers, nanomaterials and composites of these materials.

5. The device of claim 4 where in the filtration macrostructure coating is porous.

6. The device of claim 1, wherein the filtration macrostructure includes multiple layers.

7. The device of claim 1, wherein the filtration macrostructure is made from a porous material.

8. The device of claim 1, wherein the thin film coating applied to the filtration microstructure substrate is thermally stable between temperatures of (200-500° C.).

9. The device of claim 1 wherein the chemical collecting thin film coating is functionalized for a preselected chemical target.

10. The device of claim 10 wherein the preselected chemical target is selected from the group consisting of explosives, metals, volatile and semi-volatile organic compounds, gasses, drugs, radioactive targets, and chemical contaminants.

11. The device of claim 1 wherein the chemical collecting thin film coating is a nanostructured material with a high surface area.

12. The device of claim 12 wherein the thin film coating is a mesoporous or nanoporous silica.

13. The device of claim 1 wherein the chemical collecting thin film coating is a polymer.

14. The device of claim 13 wherein the polymer is a hydrophilic polymer.

15. The device of claim 1 wherein the chemical collecting thin film is a composite of porous sorbent particles in a polymer.

16. The device of claim 1 wherein the chemical collecting thin film is a composite of a nanostructured material and a polymer.

17. The device of claim 1 wherein the chemical collecting thin film coating collects the target material in such a way so as to enable collection and detection of the target material.

18. The device of claim 1 wherein the chemical collecting thin film is configured to enable direct quantification of a captured target material by a quantification device.

19. The device of claim 1 wherein the macrostructure substrate is a metal mesh filter and the chemical collecting thin-film coating is a porous ceramic polymer composite thin film selected from the group consisting of NAFION® and PVDF together with thiol functionalized mesoporous particles configured to collect Pb from river water.

20. The device of claim 1 wherein the macrostructure substrate is a metal mesh filter and the chemical collecting thin-film coating is a porous ceramic polymer composite thin film comprising Phenyl-SiO2-PDMS configured to collect an explosive vapor from a compound selected from the group consisting of DNT, TNT, or PETN from an air flow.
